(19) United States
(12) Patent Application Publication
(10) Pub. No.: US 2007/0234033 A1
(43) Pub. Date: Oct. 4, 2007

(54) Method for establishing secure distributed cryptographic objects

(76) Inventor: Steven A. Bade, Georgetown, TX (US)

Correspondence Address: IBM CORP (YA);C/O YEE & ASSOCIATES PC, P.O. BOX 802333, DALLAS, TX, 75380, US

(21) Appl. No.: 11/390,789

(22) Filed: Mar. 28, 2006

(51) Int. Cl. H04L 9/00

(52) U.S. Cl. 713/150

(57) ABSTRACT

A computer implemented method, computer program product, and system for synchronization of a set of cryptographic objects across multiple processes. The method includes maintaining a master list of the set of cryptographic objects in the object management process and encrypting a target cryptographic object at the originating process. The originating process interfaces with the object management process whenever the originating process removes, updates, or creates the target cryptographic object. The method includes synchronizing the set of cryptographic objects across the multiple processes and servers by the object management process, wherein each of the multiple processes removes or decrypts the target cryptographic object into a local cache of each of the multiple processes.

### BACKGROUND OF THE INVENTION

1. Field of the Invention

The present invention relates generally to an improved data processing system and in particular to a method and system for processing data. Still more particularly, the present invention is related to a computer implemented method, computer program product, and system for securely communicating cryptographic objects within a server network.

2. Description of the Related Art

Cryptography is used within computer and network security systems and is often built transparently into much of computing and telecommunications infrastructure. Historically, cryptography was concerned solely with converting information from its normal, comprehensible form into an incomprehensible format, rendering the information unreadable without a key. Modern cryptography provides mechanisms for more than just keeping secrets and has a variety of applications including, for example, authentication, digital signatures, electronic voting, and digital cash.

Generally-speaking, in a computer network environment, there are two types of key establishment techniques. The first technique is based on symmetric or secret key algorithms. Symmetric key algorithms are a class of algorithms that use trivially related cryptographic keys for both decryption and encryption. The encryption key is trivially related to the decryption key, in that they may be identical or there is a simple transform to go between the two keys. The keys, in practice, represent a shared secret between two or more parties that can be used to maintain a private information link.

The second technique is based on asymmetric or public key algorithms. Public key cryptography generally allows users to communicate securely without having prior access to a shared secret key. This is done by using a pair of cryptographic keys, designated as public key and private key, which are related mathematically. In public key cryptography, the private key is generally kept secret, while the public key may be widely distributed. The public key encrypts and the private key decrypts the communication. It should not be possible to deduce the private key of a pair given the public key. Typically, public key techniques are much more computationally intensive than purely symmetric algorithms, but the judicious use of these techniques enables a wide variety of applications. Hybrid techniques are also commonly used, wherein public key techniques are used to establish symmetric key encryption keys, which are then used to establish other symmetric keys.

An example use of cryptography in a network environment is in the network of “ibm.com.” A consumer logging into ibm.com may not be aware that “ibm.com” is in reality a network of computers and not a single system. When a network of computers is acting as a single computer, each server requires a digital certificate, used to identify it as “ibm.com.” In cryptography, a digital certificate is a certificate which uses a digital signature to bind together a public key with an identity—information such as the name of a person or an organization, their address, and so forth. The certificate can be used to verify that a public key belongs to an individual.

The signatures on a certificate are attestations by the certificate signer that the identity information and the public key belong together. The identity and authorization information are stored in key-stores. Across a large network of systems these key-stores are difficult to manage. In an example where each server has its own cryptographic module, that is its own computational resources and key-store, the servers are unaware of each other. Sharing a key-store between them is cumbersome. Furthermore, in an example where there is a shared distributed key-store keeping the key-store cache on each system synchronization is a problem, as well as allocating the cryptographic computational resources across the network.

### SUMMARY OF THE INVENTION

The present invention provides a computer implemented method, computer program product, and system for synchronization of a set of cryptographic objects across multiple processes and includes at least an object management process and an originating process. A master list of the set of cryptographic objects is maintained in the object management process. A target cryptographic object at the originating process is encrypted. The originating process interfaces with the object management process whenever the originating process removes, updates, or creates the target cryptographic object. The set of cryptographic objects are synchronized across the multiple processes by the object management process, wherein each of the multiple processes removes or decrypts the target cryptographic object into a local cache of each of the multiple processes.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which aspects of the present invention may be implemented;

FIG. 2 is a block diagram of a data processing system in which aspects of the present invention may be implemented;

FIG. 3 is a block diagram of multiple processes in a plurality of systems in accordance with an illustrative embodiment of the present invention;

FIG. 4 depicts a block diagram of another illustrative embodiment of the present invention;

FIG. 5 is a flowchart that illustrates a cryptographic module initialization method in accordance with an illustrative embodiment of the present invention;

FIG. 6 is a flowchart that illustrates a method for a basic flow of a cryptographic object on a local node in accordance with an illustrative embodiment of the present invention; and

FIG. 7 is a flowchart that illustrates the interaction between a local node and the object management master during the creation of a cryptographic key in accordance with an illustrative embodiment of the present invention.

### DETAILED DESCRIPTION OF THE PREFERRED EMBODIMENT

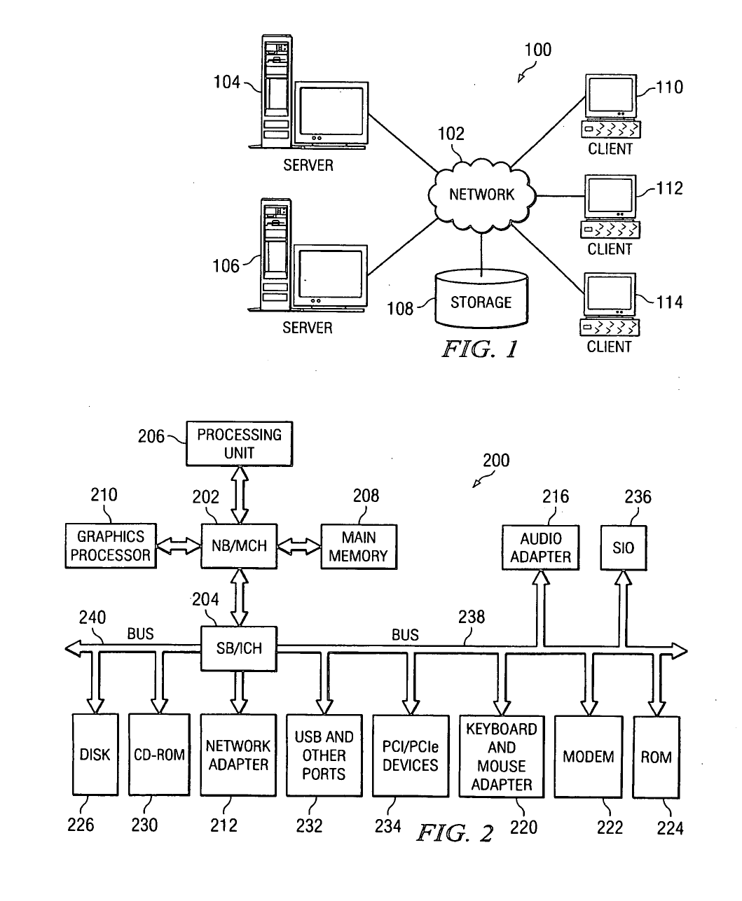

With reference now to the figures and in particular with reference to FIGS. 1-2, exemplary diagrams of data processing environments are provided in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ pSeries® computer system, running the Advanced Interactive Executive (AIX®) operating system or the LINUX® operating system (eServer, pSeries and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for embodiments of the present invention are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course, the bus system may be implemented using any type of communication fabric or architecture that provides for a transfer of data between different components or devices attached to the fabric or architecture. A communication unit may include one or more devices used to transmit and receive data, such as modem 222 or network adapter 212 of FIG. 2. A memory may be, for example, main memory 208, ROM 224, or a cache such as found in NB/MCH 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

The present invention provides a computer implemented method to synchronize a set of cryptographic objects across multiple processes and servers. The computer method maintains a master list of the set of cryptographic objects in an object management process, and encrypts a target cryptographic object at the originating process. The originating process interfaces with the object management process whenever the originating process removes, updates, or creates the target cryptographic object. The computer implemented method also synchronizes the set of cryptographic objects across the multiple processes and servers by the object management process, wherein each of the multiple processes removes or decrypts the target cryptographic object into a local cache of each of the multiple processes.

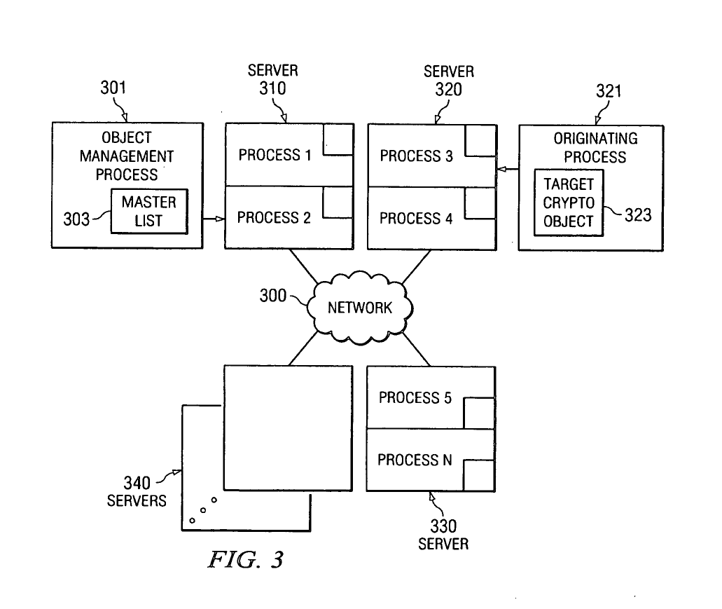

Referring to FIG. 3, a block diagram of a plurality of systems connected to a network is depicted in accordance with an illustrative embodiment of the present invention. Network 300 connects to a plurality of servers, consisting of servers 310, 320, 330, and 340, in this illustrative embodiment of the present invention. Servers 340 represent a set of zero or more servers. The servers connect to each other and other devices through a network as illustrated in FIG. 2. Each server may support a single or multiple processes. Multiple processes exist wherein more than one process runs on a single server or more than one process runs across a network. An example of a multiple process server is a server that is administering two Web sites. Each process on each server has a cache memory for local storage of cryptographic objects. A cache memory is a fast storage buffer in the central processing unit of a computer. An object is a self-contained entity that consists of both data and procedures to manipulate the data. A cryptographic object is an object that consists of both data and procedures pertaining to cryptography.

Servers 320, 330, and 340 do not compute cryptographic data for their processes but share computational cryptographic resources with server 310. Also, the cryptographic modules associated with each server do not contain the permanent key-store locally, but share a permanent key-store in master storage server 310. The key-stores must be synchronized.

One of the multiple processes in server 310 is object management process 301. In this illustrative embodiment of the present invention, the cryptographic computational resources and object management process 301 reside on server 310; however, cryptographic computational resources and object management process 301 could reside on different servers within network 300. An object management process manages the synchronization of cryptographic objects for multiple processes. Object management process 301 manages the synchronization of cryptographic objects for the multiple processes across plurality of servers 310, 320, 330, and 340. Object management process 301 contains master list 303. Master list 303 is a list referencing cryptographic objects and their descriptions. As a process updates, creates, or deletes objects, these changes are reflected in master list 303. A cryptographic object being updated, created or deleted is a target cryptographic object. The process that initiates the update, creation or deletion is the originating process.

Master list 303 is updated by incrementing a reference count in response to an update of a cryptographic object of any of the multiple processes connected to network 300. A reference count tracks updates to cryptographic objects by incrementing a counter each time a change is made to a cryptographic object. In response to a cryptographic object being added to or deleted from one of the multiple processes, an addition or deletion is made to master list 303. An originating process is a process that initiates a change to the set of cryptographic objects controlled by the object management process. A set of cryptographic objects is one or more cryptographic object. Master list 303 has an updated list of all cryptographic objects in network 300. Before processes use cryptographic objects on the local servers, master list 303 is compared to the process' local cache list to determine whether the local cache list is the same as master list 303. If the lists are not the same, the lists are synchronized before the cryptographic processes begin.

This synchronization may be done by a multi-process cache coherency daemon. A daemon is a background process. Cache coherency refers to the integrity of data stored in local caches of a shared resource. When processes in a multi-process system maintain caches of a common memory resource, such as the cryptographic object cache of the present invention, synchronization problems may arise.

If a process in server 330 has a copy of a memory block from a previous read and an originating process in server 320 changes that memory block, the other processes in server 320 and the processes reside on servers 310, 330, and 340 could be left with an invalid cache of memory, with no knowledge that the cache is invalid. Cache coherence is intended to manage such conflicts and maintain consistency between cache and memory. Cryptography cache coherency daemons are background processes that in the past have synchronized caches across a single server or client. The present invention expands a single system cache coherency daemon to a daemon that synchronizes multiple processes contained within a plurality of systems. Thus, a multiple process cache coherency daemon is a background process that synchronizes multiple processes. A remote daemon is a daemon that is local to one system.

Server 320 contains multiple processes including originating process 321. Originating process 321 is shown in the process of creating a new cryptographic object called, target crypto object 323, in this illustrative embodiment of the present invention. Target crypto object 323 will be referenced in master list 303. The other processes in server 320 as well as all the processes in servers 310, 330, and 340 will be updated by object management process 301 so that their local caches reflect the addition of target crypto object 323.

Those of ordinary skill in the art can appreciate that the present invention may be implemented in several ways. The master list based cache coherence mechanism as illustrated above is only one example.

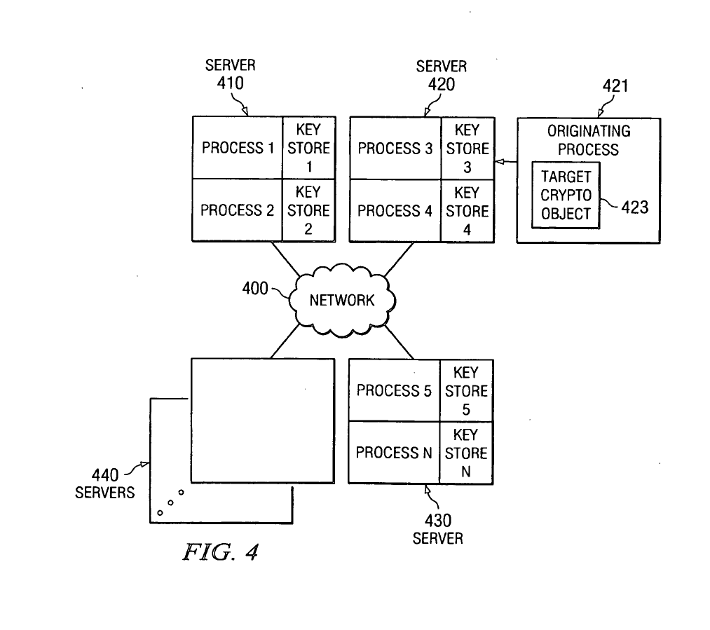

Turning now to FIG. 4, a block diagram of another illustrative embodiment of the present invention is depicted. In this embodiment, each server has a cryptographic module. A cryptographic module contains the computational resources necessary to handle the cryptographic needs of the server and a key-store that holds the cryptographic objects. Cryptographic resources are not shared as depicted in FIG. 3. Cryptographic modules contain cryptographic algorithm capabilities, persistent key storage, temporary key storage, and interfaces to programs. A key is a password or table needed to decipher encoded data. Temporary keys have only local use and do not get distributed. Persistent keys are keys that are not temporary and are stored in a key-store. Cryptographic module boundaries can be a physical or a logical construct with various degrees of protection from the outside world. In FIG. 4 originating process 421 creates target crypto object 423 in its local cryptographic module and updates its own key-store on server 420. Originating process 421 then “advertises” the new cryptographic object across network 400, so that each of the processes on servers 410, 420, 430, and 440 obtain an encrypted copy of target crypto object 423 to decrypt into its own key-store.

A cross-system permanent key-store cache coherency daemon communicates the permanent key-store updates throughout the system. Cache coherency is the property of the shared memory systems multiprocessors and distributed shared memory systems in which any shared piece of memory gives consistent values despite accesses from different system processors.

A daemon is a process run in the background. Thus, a cross-system permanent key-store cache coherency daemon is a background process that ensures the integrity of local permanent key-stores across a plurality of systems. Those of ordinary skill in the art could use many of the different methods to implement the cross-system permanent key-store cache coherency daemon or other methods to assure cross system cache coherency in the spirit and scope of the present invention.

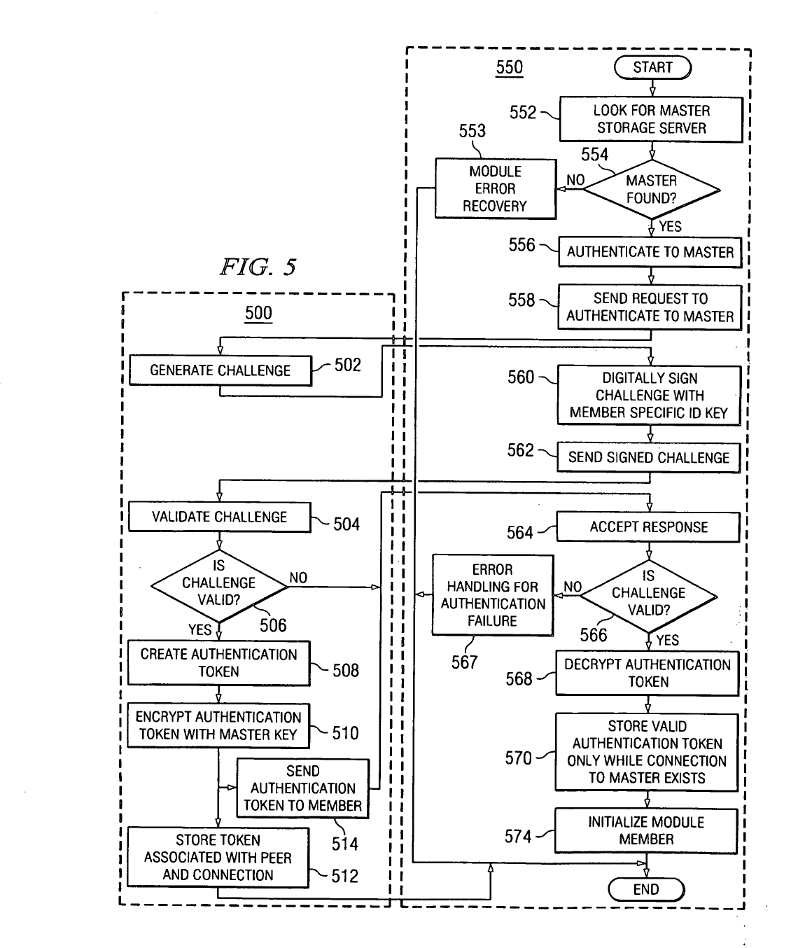

Referring now to FIG. 5, a flowchart of a cryptographic module initialization method in accordance with an illustrative embodiment of the present invention, as shown in FIG. 3. FIG. 5 is divided into two general areas. Area 500 indicates processes that occur in the master storage server and area 550 indicates processes that occur in member to be initialized. Upon startup the member looks for the master storage server (step 552). A determination is made as to whether the master storage server is found (step 554). If the master storage server is not found (no output of step 554), the member goes to an error recovery module (step 553) with the process terminating thereafter. If the master storage server is found (yes output of step 554), the member begins authentication to the master storage server (step 556). Then a request to authenticate to the master is sent (step 558). The master storage server generates a challenge (step 502) and sends the challenge back to the member. A challenge is a query that can only be answered if the member has the correct information. A challenge is typically a random number sent to the client machine. The member signs the challenge with a member specific ID key (step 560) and sends the signed challenge back to the master storage server (step 562). The master storage server attempts to validate the challenge sent by the member (step 504). A determination is made as to whether the challenge is valid (step 506). If the challenge is invalid (yes output of step 506), a message is sent to the member and the member accepts the response (step 564). The member checks to see if the challenge is validated (step 566), if it is invalid (no output of step 566), an error handling for authentication failure is implemented (step 567) with the process terminating thereafter. A challenge and response system may also work with an authentication token, which is a smart card or credit-card sized card that users have in their possession. An authentication token can also be a software password. When logging on, the user responds to the challenge by either inserting their smart card into a reader, typing in the password displayed on the card's readout, or by a computer system providing a software password.

Referring back to the master storage server at step 506, if the challenge is valid (yes output at step 506), the master storage server creates an authentication token (step 508). The master storage server encrypts the authorization token with the master key (step 510). The encrypted master key authorization object is stored in persistent key-store with peer and connection (step 512) with the process terminating thereafter. Returning to step 510, the encrypted master key authorization token is also sent to the member (step 514), and then the member accepts the response (step 564). The member then checks to see if the challenge is valid (step 566). If the challenge is valid (yes output of 566), the member decrypts the authorization token (step 568). The member stores the authorization token (step 570) and the member is initialized (step 574) with the process terminating thereafter. The authorization token is only valid while connection to the master storage server exists.

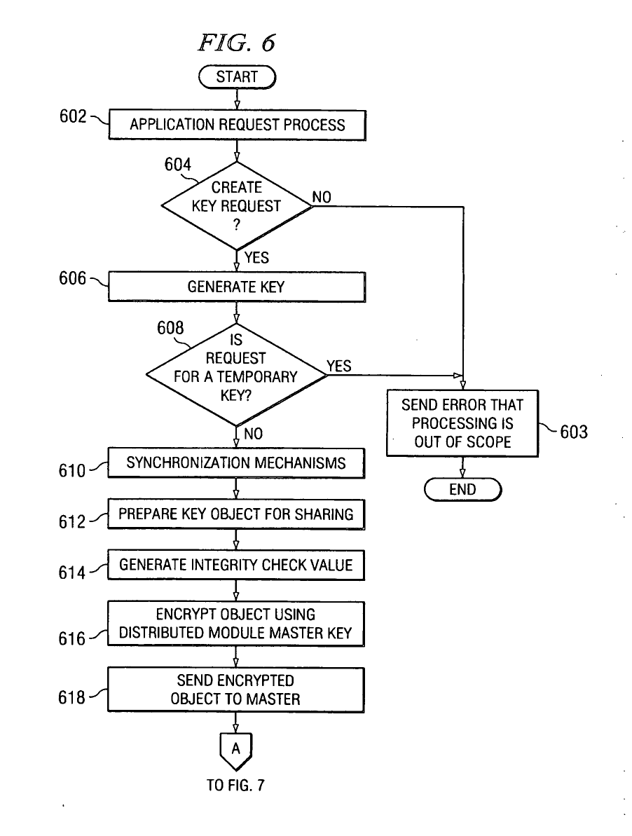

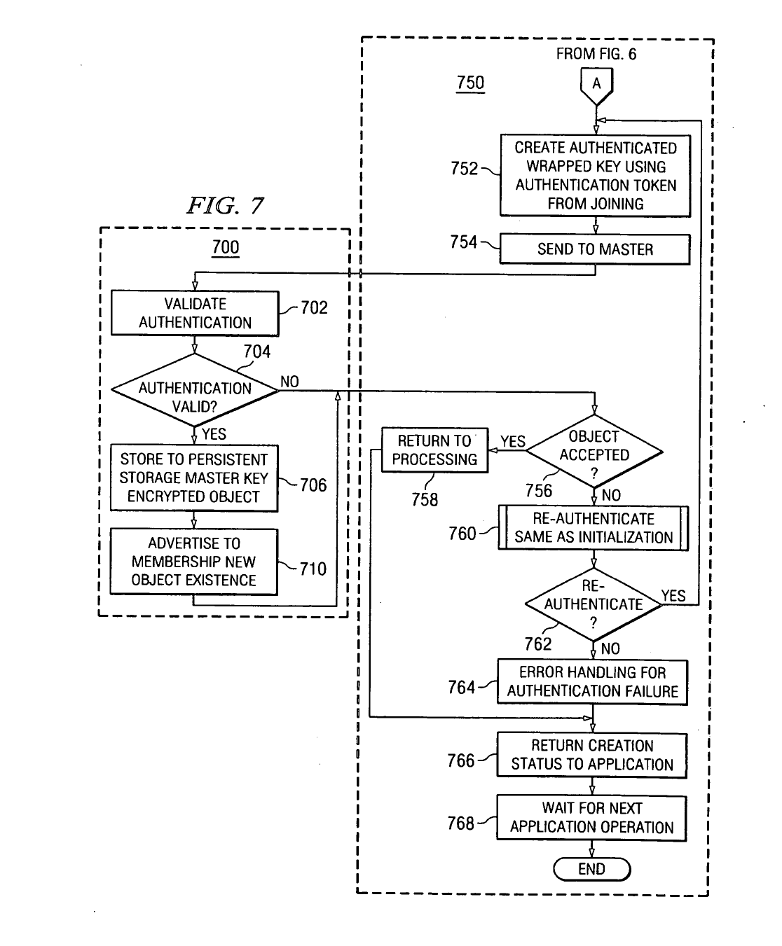

Referring now to FIG. 6, a flowchart of a creation of a cryptographic key in accordance with an illustrative embodiment of the present invention. The application request process begins (step 602). A determination is made as to whether the request is a key request (step 604). If it is not a key request (no output at step 604), the application is out of scope for this flow (step 603) with the process terminating thereafter. If a request for a key has been made (yes output at step 604), the application generates a key (step 606). A determination is made as to whether the key is a temporary key (step 608). If the request is for a temporary key (yes output at step 608), the processing is out of scope for this flow (step 603) with the process terminating thereafter. If the request is for a persistent key (no output at step 608), then the application goes to synchronization mechanisms (step 610). FIG. 6 shows an example of a means of synchronization however; those of ordinary skill in the art could implement many means of synchronization, in the spirit of the present invention. Next, the key object is prepared for sharing (step 612). An integrity check value is generated (step 614). And then the key object is encrypted using the distributed module master key from the master storage server (step 616). Protection of this key provides ultimate security for the object. The master key encrypted key object is then sent to the master storage server (step 618).

Referring now to FIG. 7, a flowchart of a cross-system permanent key-store cache coherency daemon implementation method. There are two general areas depicted in FIG. 7. Area 700 is the master storage server and area 750 is the member. Referring back to FIG. 3, master storage server depicts an object management process, similar to object management process 301, and the member depicts an originating process, similar to originating process 321. An authenticated wrapped key is created using authentication token from joining with the master storage server (step 752). The authenticated wrapped key is sent to the master (step 754). The master then initiates validate authentication (step 702). A determination is made concerning the authentication (step 704), if the authentication is valid (yes output of step 704), the master stores the authenticated wrapped key to persistent key-store (step 706). Next, the new object is announced to members in an object accepted notification (step 710). A check is made to see if the object is accepted (step 756). If the object is accepted (yes output to step 756), the member returns to processing (step 758).

Returning to step 704, if the authentication is not valid (no output at step 704), the object is returned as not accepted (step 756). The process goes then to re-authenticate (step 760). A determination is made as to whether the re-authentication is successful (yes output at step 762), the process returns to create authenticated wrapped key using authentication token from joining (step 752). If the re-authentication is unsuccessful (no output at step 762), the process falls to error handling for authorization failure (step 764). After the return to processing (step 758), the process returns object creation status to the application (step 766). After error handling for authentication failure (step 764), the process returns object creation status to the application (step 766). The process then waits for the next application operation (step 768) with the process terminating thereafter.

The present invention provides a computer implemented method to synchronize a set of cryptographic objects across multiple processes and servers. The computer implemented method includes maintaining a master list of the set of cryptographic objects in an object management process, and encrypting a target cryptographic object at the originating process. The originating process interfaces with the object management process whenever the originating process removes, updates, or creates the target cryptographic object. The computer implemented method includes synchronizing the set of cryptographic objects across multiple processes and servers by the object management process, wherein each of the multiple processes removes or decrypts the target cryptographic object into a local cache of each of the multiple processes.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for synchronization of cryptographic objects across multiple processes, including at least an object management process and an originating process, comprising:
maintaining a master list of the set of cryptographic objects in the object management process;
encrypting a target cryptographic object at the originating process;
interfacing the originating process with the object management process when the originating process removes, updates, or creates the target cryptographic object; and
synchronizing the set of cryptographic objects across multiple processes by the object management process;
wherein each of the multiple processes removes or decrypts the target cryptographic object into a local cache of each of the multiple processes.

2. The computer implemented method of claim 1, wherein the multiple processes resides in a plurality of systems.

3. The computer implemented method of claim 2, wherein the synchronizing is accomplished by a multiple process cache coherency daemon.

4. The computer implemented method of claim 2, further comprising:
preparing the target cryptographic object for sharing;
generating a set of integrity check values;
encrypting the target cryptographic object using an object management process master key; and
sending the target cryptographic object to the object management process, wherein the object management process validates an authentication, updates the master list with the target cryptographic object and notifies the multiple processes that the target cryptographic object is ready for decryption.

5. The computer implemented method of claim 2, further comprising:
adding a new member of the multiple processes;
sending a request for authentication from the new member to the object management process;
digitally signing a challenge sent to the new member from the object management process and returning the signed challenge to the object management process;
accepting an encrypted authentication token from the object management process;
decrypting authentication token; and
storing and using authentication token.

6. A computer implemented method for synchronization of a set of cryptographic objects across multiple processes comprising:
creating a target cryptographic object within a local space of an originating process;
interfacing the originating process with the multiple processes; and
synchronizing the multiple processes with the target cryptographic object by the originating process, wherein the target cryptographic object is encrypted at the originating process and is only decrypted at each of the multiple processes.

7. The computer implemented method of claim 6, wherein the multiple processes resides in a plurality of servers, and wherein at least two of the plurality of servers has cryptographic computing resources.

8. The computer implemented method of claim 7, wherein the synchronizing method is a multiple process cache coherency daemon, and wherein the multiple process cache coherency daemon instructs each of a set of remote daemons to perform a set of synchronization operations on each of the set of cryptographic objects of each of the plurality of servers.

9. A computer program product comprising:
a computer usable medium including computer usable program code for synchronization of a set of cryptographic objects across multiple processes, including at least an object management process and an originating process, the computer program product comprising:
computer usable program code for maintaining a master list of the set of cryptographic objects in the object management process;
computer usable program code for encrypting a target cryptographic object at the originating process;
computer usable program code for interfacing the originating process with the object management process when the originating process, removes, updates, or creates the target cryptographic object; and
computer usable program code for synchronizing the set of cryptographic objects across the multiple processes by the object management process; wherein each of the multiple processes removes or decrypts the target cryptographic object into a local cache of each of the multiple processes.

10. The computer program product of claim 9, wherein the multiple processes resides in a plurality of servers.

11. The computer program product of claim 10, further comprising computer usable program code wherein the synchronization is accomplished by a multiple process cache coherency daemon.

12. The computer program product of claim 11, further comprising:
computer usable program code wherein a cryptographic object is prepared for sharing;
computer usable program code for generating a set of integrity check values;
computer usable program code for encrypting the cryptographic object using an object management process master key;
computer usable program code for sending the target cryptographic object to the object management process;
computer usable program code for the object management process validation of an authentication;
computer usable program code for updating the master list with the target cryptographic object; and
computer usable program code for notification of the multiple processes that the target cryptographic object is ready for decryption.

13. The computer program product of claim 10, wherein a new member of the multiple processes is added, comprising:
computer usable program code for sending a request for authentication to the object management process;
computer usable program code for digitally signing a challenge sent from the object management process and returning the signed challenge to the object management process;
computer usable program code for accepting an encrypted authentication token from the object management process;
computer usable program code for decrypting authentication token; and
computer usable program code for storing and using authentication token.

14. The computer program product comprising:
a computer usable medium including computer usable program code for synchronization of a set of cryptographic objects across multiple processes, comprising:
computer usable program code for creating a target cryptographic object within a local space of an originating process;
computer usable program code for interfacing the originating process with the multiple processes; and
computer usable program code for synchronizing the multiple processes with the target cryptographic object by the originating process, wherein the target cryptographic object is encrypted at the originating process and is only decrypted at each of the multiple processes.

15. A system for synchronizing of a set of cryptographic objects across multiple processes, including at least an object management process and an originating process, the system comprising:
an encryption resource for executing a set of instructions for encrypting a target cryptographic object at the originating process;
an interfacing resource for executing a set of instructions for interfacing the originating process with the object management process when the originating process removes, updates, or creates the target cryptographic object; and
a synchronizer for executing a set of instructions for maintaining a master list of the set of cryptographic objects in the object management process, and for synchronizing the set of cryptographic objects across the multiple processes by the object management process, wherein each of the multiple processes removes or decrypts the target cryptographic object into a local cache of each of the multiple processes.

16. The system of claim 15, wherein the multiple processes resides in a plurality of systems.

17. The system of claim 15, wherein the synchronizer is a multiple process cache coherency daemon.

18. The system of claim 15, wherein responsive to a change in the target cryptographic object, the origination member includes:
a mechanism to prepare the target cryptographic object for sharing;
a mechanism to generate a set of integrity check values;
a mechanism to encrypt the target cryptographic object using an object management process master key;
a mechanism to send the target cryptographic object to the object management process, and wherein the object management process;
a mechanism to validate an authentication;
a mechanism to update the master list with the target cryptographic object; and
a mechanism to notify the multiple processes that the target cryptographic object is ready for decryption.

19. The system of claim 15, wherein a new member of the multiple processes is added, the new member includes:
a mechanism to send a request for authentication to the object management process,
a mechanism to digitally sign a challenge sent from the object management process and to return the signed challenge to the object management process,
a mechanism to accept an encrypted authentication token from the object management process,
a mechanism to decrypt authentication token, and
a mechanism to store and use authentication token.

20. A system for synchronizing a set of cryptographic objects across multiple processes, the system comprising:
an interfacing resource wherein the interfacing resource executes a set of instructions to interface the originating process with the multiple processes; and
a synchronizing resource that executes a set of instructions for creating a target cryptographic object within a local space of an originating process, and synchronizing the multiple processes with the target cryptographic object by the originating process, wherein the target cryptographic object is encrypted at the originating process and is only decrypted at each of the multiple processes.
